(19) United States
(12) Patent Application Publication
(10) Pub. No.: US 2002/0185537 A1
(43) Pub. Date: Dec. 12, 2002

(54) Bar code reader for accessing plural servers and bar code based method for accessing plural servers

(75) Inventor: Kazuhiko Konda, Chuo-ku (JP)

Correspondence Address: OLIFF & BERRIDGE, PLC, P.O. BOX 19928, ALEXANDRIA, VA, 22320, US

(73) Assignee: Media Portal Japan Co., Ltd., Chuo-ku (JP)

(21) Appl. No.: 10/136,366

(22) Filed: May 2, 2002

(30) Foreign Application Priority Data
May 31, 2001 (JP) 2001-165922
Jul. 6, 2001 (JP) 2001-206219

(51) Int. Cl. G06K 7/10

(52) U.S. Cl. 235/462.01

(57) ABSTRACT

A single bar code is allocated to a plurality of servers according to given conditions by matching a single bar code with a plurality of URLs. The bar code reader of the present invention comprises a bar code reading portion for reading a bar code; a storage portion for pre-storing the relation between an identifier and a server URL; an analyzing portion for extracting an identifier from a bar code that is read and for obtaining the corresponding URL by searching the above-mentioned storage portion on the basis of the above-mentioned identifier; and a communications portion for transmitting the above-mentioned URL and the above-mentioned bar code data.

### BACKGROUND OF THE INVENTION

1. Field of the Invention

The present invention relates to a bar code reader that may be used to access a predetermined server by reading a bar code printed in a newspaper, magazine, or on an insert, or the like, and to a method that employs this bar code reader to access a plurality of servers.

2. Description of the Related Art

A multiplicity of servers are connected to the Internet that provide varied content. A variety of search engines are also provided for selecting a desired server from among these servers and for accessing this server. Alternatively, users also access these servers by calling up URLs that are printed in media other than the Internet, such as newspapers, magazines and inserts. In order that users actually access these servers, the content on these servers (web sites) must be made appealing, and access to such content must be straightforward.

As a method for making access to a predetermined URL straightforward, bar codes have been employed. In other words, bar codes are printed in printed media such as newspapers, magazines and inserts, or the like, and a bar code is read using a bar code reader connected to a personal computer, and converted to a URL. The jump to this URL is then performed by means of a browser running automatically. Such an access method is simple and reliable and the extensive usage thereof is anticipated in the future.

The conventional method of accessing a predetermined server on the basis of a bar code (bar code-URL conversion method) involves sending a bar code number, which has been received from a bar code reader, to a bar code-URL conversion server that has been pre-specified by personal computer, receiving a converted URL, and using this to access a predetermined Web server.

Conventionally, one bar code-URL conversion server has been used, but a demand has arisen to provide a plurality of bar code-URL conversion servers, so that these conversion servers are distributed among the users thereof.

### SUMMARY OF THE INVENTION

The present invention is intended to meet such requirements, and an object thereof is to provide a bar code reader, which is capable of matching a single bar code with a plurality of URLs and of thus permitting access to any given server, and a method for accessing a plurality of servers on the basis of this bar code. According to the present invention, a user can be easily directed to a predetermined server chosen from among a plurality thereof.

The bar code reader according to the present invention comprises a bar code reading portion for reading a bar code; a storage portion for pre-storing the relation between an identifier and a server URL; an analyzing portion for extracting an identifier from a bar code that is read and for obtaining the corresponding URL by searching the above-mentioned storage portion on the basis of the above-mentioned identifier; and a communications portion for transmitting at least the above-mentioned URL.

The bar code reader according to the present invention comprises a bar code reading portion for reading a bar code; a storage portion for pre-storing the relation between a party through which connection is to be made (hereinafter referred to as “connecting party”) and a server URL, and for storing information on the connecting party; an analyzing portion for obtaining the corresponding URL by searching the above-mentioned storage portion on the basis of the above-mentioned information on the connecting party; and a communications portion for transmitting at least the above-mentioned URL and, during connection with the above-mentioned connecting party, for obtaining the above-mentioned connecting party information and storing same in the above-mentioned storage portion.

The bar code reader according to the present invention comprises a bar code reading portion for reading a bar code; a storage portion for pre-storing the relation between an identifier and a server URL and for storing the above-mentioned identifier; an analyzing portion for obtaining the corresponding URL by searching the above-mentioned storage portion on the basis of the above-mentioned identifier; and a communications portion for transmitting at least the above-mentioned URL.

The bar code reader according to the present invention comprises a bar code reading portion for reading a bar code; a switch for specifying an identifier; a storage portion for pre-storing the relation between the above-mentioned identifier and server URL; an analyzing portion for obtaining the corresponding URL by searching the above-mentioned storage portion on the basis of the identifier that has been specified by the above-mentioned switch; and a communications portion for transmitting at least the above-mentioned URL.

The bar code reader according to the present invention comprises a bar code reading portion for reading a bar code; a favorites memory for storing specified bar code data as a new favorite; and a communications portion for transmitting the above-mentioned bar code data.

The method, according to the present invention, for accessing a plurality of servers on the basis of a bar code comprises the steps of: storing a table that indicates the relations between identifiers and server URLs; reading a bar code; extracting an identifier from the read bar code; obtaining the corresponding URL by searching the above-mentioned table on the basis of the above-mentioned identifier; and accessing a server on the basis of the above-mentioned URL.

### BRIEF DESCRIPTION OF THE DRAWINGS

FIG. 1 is a block diagram of a bar code reader according to a first embodiment of the present invention.

FIG. 2 is a figure showing the overall configuration of a bar code-URL conversion system, in which the bar code reader is employed, according to the first embodiment of the present invention.

FIG. 3 is a flow chart for processing by the bar code-URL conversion system, in which the bar code reader is employed, according to the first embodiment of the present invention.

FIG. 4 is a flow chart for processing by the bar code reader according to the first embodiment of the present invention.

FIG. 5 is a flow chart for processing by a client according to the first embodiment of the present invention.

FIG. 6(a) is a block diagram of a bar code reader according to a second embodiment of the present invention.

FIG. 6(b) is a block diagram of a URL conversion server according to the second embodiment of the present invention.

FIG. 7 is a flow chart for processing by a bar code-URL conversion system, in which the bar code reader is employed, according to the second embodiment of the present invention.

### DESCRIPTION OF THE PREFERRED EMBODIMENTS

First Embodiment of the Invention

A first embodiment of the present invention will be explained hereinbelow referring to the drawings.

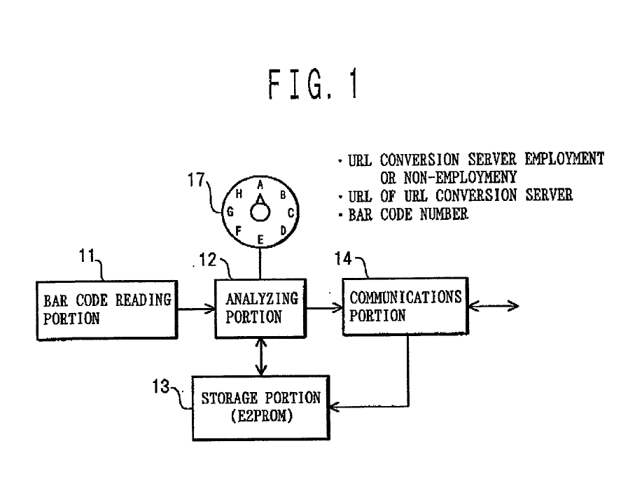

FIG. 1 is a schematic view of the constitution of a bar code reader according to a first embodiment of the present invention. A bar code, which has been printed in a newspaper, magazine, insert, or the like, is read using a bar code reading portion 11. Analyzing portion 12 then analyzes the read bar code. In specific terms, the bar code is divided into an identifier, for a URL conversion server, and a bar code number, and, by referencing a URL table of URL conversion server identifiers conversion server URLs, which has been stored in storage portion 13, the URL conversion server identifier is converted to a conversion server URL. Communications portion 14 receives a conversion server URL and bar code number from analyzing portion 12 and transmits same to a personal computer, mobile telephone and/or digital TV that is the client. Further, when the bar code reader is employed for normal use, since no especial use is made of a URL conversion server, information to that effect is output. Storage portion 13 comprises an E2PROM and is capable of electrical rewriting. Communications portion 14 receives updated table information from the information server described hereinbelow and stores this information in storage portion 13.

Task-change switch 17 is a rotary switch for directly selecting a use, for the bar code reader, and a URL conversion server that is to be employed. Switch 11 selects any one of eight states A through H. In state A (the state shown in FIG. 1), direct input is selected as the bar code reader input mode. Here, data, which has been read using the bar code reader, can be employed for normal use. States B through H are modes for performing bar code-URL conversion. As noted hereinbelow, states B through H each correspond to a different conversion server.

| Switch position | Task |
|---|---|
| A | Direct input |
| B | URL conversion: conversion server |
| | http:///www.mediapj.com/ |
| C | URL conversion: conversion server |
| | http:///www.henkan1.henkan/ |
| D | URL conversion: conversion server |
| | http:///www.henkan2.henkan/ |
| E | URL conversion: conversion server |
| | http:///www.henkan3.henkan/ |
| F | URL conversion: conversion server |
| | http:///www.henkan4.henkan/ |
| G | URL conversion: conversion server |
| | http:///www.henkan5.henkan/ |
| H | URL conversion: conversion server |
| | http:///www.henkan6.henkan/ |

The above-mentioned URLs for URL conversion servers are stored in storage portion 13.

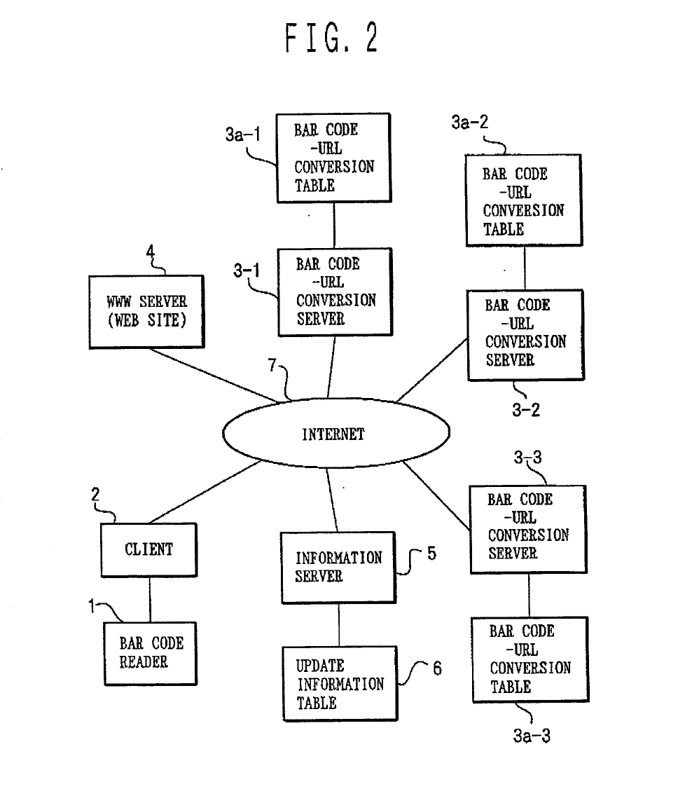

FIG. 2 shows the overall configuration of the system in which bar code reader 1 is employed. Client 2, that has bar code reader 1 connected thereto, bar code-URL conversion servers 3-1 through 3-3, WWW server 4 and information server 5 are connected to the Internet 7, whereby it is possible to perform data communication therebetween. Conversion servers 3-1 through 3-3 respectively comprise bar code-URL conversion tables 3a-1 through 3a-3. Tables 3a have the relation between bar code numbers and URLs that correspond thereto pre-stored therein.

The system of FIG. 2 is intended for the reading of a bar code and access to a predetermined site, and this system comprises a client 2 that may be in the form of a personal computer, mobile telephone, digital TV, or the like. The bar code reader 1 is connected to the client, and a bar code, which is printed on a medium such as a newspaper, magazine, or insert, or the like, can be thus read. The read bar code is converted to the corresponding URL using URL conversion server 3. Client 2 is then able to access a desired server 4 on the basis of the read URL. A URL, which corresponds to the bar code printed on the medium, is preset and the relation between the URL and the bar code is pre-stored in bar code-URL conversion table 3a. For example, if a bar code, which indicates a company Web site is printed in a newspaper advertisement, it is possible to direct a user to this company Web site by means of a simple operation. Further, “URL” is an acronym for “uniform resource location” and is a means for describing in a certain format the location and name of a resource that has been distributed over and is present on the Internet. In other words, a URL also indicates the existence (address) of a resource present on a computer network.

The system in FIG. 2 comprises a plurality of conversion servers 3 (this is an example, it also being possible to provide one server with the capability of a plurality of conversion servers). The purpose thereof is to allocate the conversion servers used for each read bar code. A merit of such a system lies in the fact that a bar code provider is able to direct a user to a conversion server owned by itself.

Further, the system in FIG. 2 further comprises an information server 5 and an update information table 6 that serve to update the contents of the E2PROM in storage portion 13 of bar code reader 1. A detailed description thereof is provided hereinbelow.

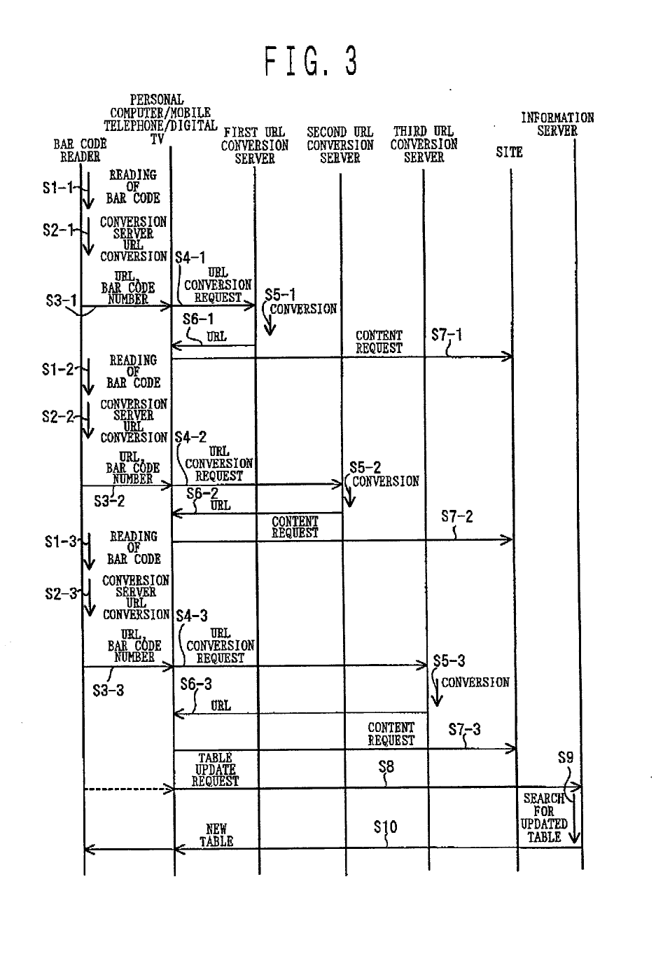

FIG. 3 is a flow chart for processing by the system of FIG. 2. In this figure, S1-1 through S7-1 illustrate actions when a given bar code is read, and S1-2 through S7-2, and S1-3 through S7-3 illustrate actions when other bar codes are read. These actions are the same except for the fact that the conversion server differs to which URL conversion is requested. Hereinbelow, these actions are explained as a whole.

S1: A bar code printed on a medium is scanned using bar code reader 1, and the bar code number and URL conversion server identifier of this bar code are read.

S2: The URL of the conversion server to be employed is acquired by referencing storage portion 13 on the basis of the above-mentioned identifier.

S3: The above-mentioned URL and bar code number are sent to the client.

S4: The URL conversion server is accessed on the basis of the above-mentioned URL, and URL conversion of the bar code number is requested.

S5: The URL of the site that corresponds to the bar code number is acquired using the URL conversion server.

S6: The converted URL is sent to the client.

S7: A predetermined site is accessed on the basis of the acquired URL, and the content is acquired.

Further, actions, when the task change switch of FIG. 1 is employed, are as follows:

S1′: A bar code printed on a medium is scanned using bar code reader 1, and the bar code number of this bar code is read.

S2′: The URL of the conversion server to be employed is acquired by referencing storage portion 13 on the basis of the identifier (B to H) indicated by task change switch 17. Further, when the identifier=A, the bar code number is output to the client as is.

Actions S3′ to S7′ are the same as S3 to S7.

Processing steps S8 through S10 of FIG. 3 serve to update the information on URL conversion server. Modification of the URL of the URL conversion server in accordance with conditions of the service provider, etc. has also been considered. In such circumstances, the capacity for automatic updating of the content in storage portion 13 of bar code reader 1 is of benefit to the user, and a further merit lies in always being able to hold updated bar codes.

S8: Client 2 outputs a request to update the table to information server 5. Possible times for an update request may be: when client 2 is initialized or turned on, or when same performs a predetermined operation, or every time a set interval has elapsed or a set number of read processings have been performed, before a second process occurs (initially a first conversion server is accessed, but, the second time and thereafter, a second conversion server is accessed), and so forth. Furthermore, client 2 may also transmit an update request in response to a request from bar code reader 1.

S9: Information server 5 searches for update information table 6 to determine whether or not an updated table exists.

S10: When an updated table is present, this table is sent to client 2. This table is sent from client 2 to bar code reader 1 and stored in storage portion 13.

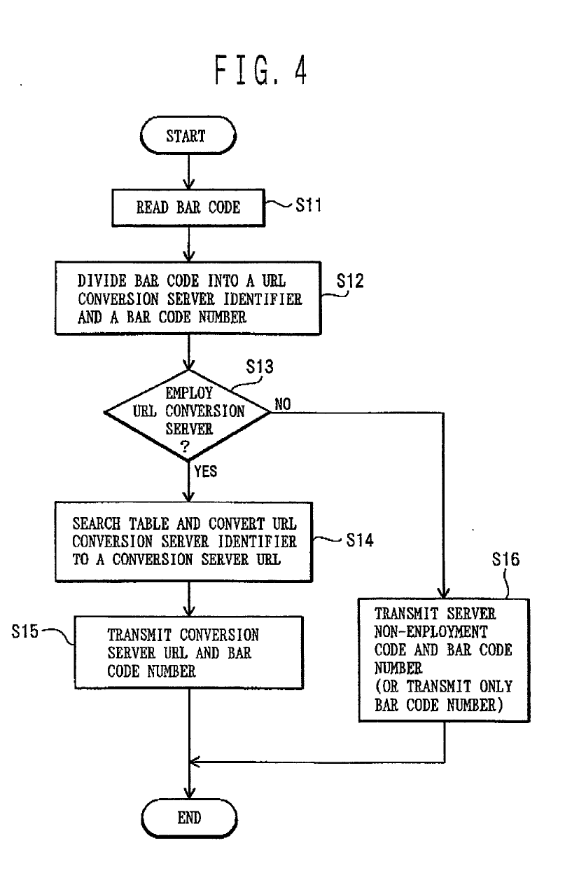

FIG. 4 shows a flow chart for processing of bar code reader 1.

S11: The bar code is read.

S12: The bar code is divided into a URL conversion server identifier and a bar code number.

Examples of read bar codes are as follows:

49xxxxxxxxxx

45xxxxxxxxxx

41xxxxxxxxxx

The leading digits “49”, “45” and “41” are identifiers.

Further, when task change switch 17 is employed, the identifier may be any of identifiers A to H.

S13: A judgment is made as to whether a URL conversion server should be used.

If the above-mentioned identifier is present, a conversion server is employed. It no such identifier is present, or a special identifier (for example “40”) is present, a conversion server is not employed. Alternatively, when a predetermined kind of bar code is read, a conversion server is not employed (or is employed). For example, a case in which a bar code reader is employed simply as a data-reading means corresponds to a case in which a conversion server is not employed.

When the task change switch is used, a conversion server is not employed when the identifier=A.

S14: when a conversion server is employed, the table in storage portion 13 is searched and the identifier for the URL conversion server is converted to a conversion server URL.

For example, conversion is performed as noted below:

For 49: http;//www.mediapj.com/

For 45: http://www.hogehoge.com/

For 41: http://www.foo.com/

When the task change switch is used, the identifier is converted to a conversion server URL on the basis of the relations noted above.

S15: The conversion server URL and bar code number (the above-mentioned xxxxxxxxxx portion) are transmitted.

S16: When the conversion server is not employed, a server non-employment code and bar code number are transmitted. Alternatively, the bar code number alone may be transmitted.

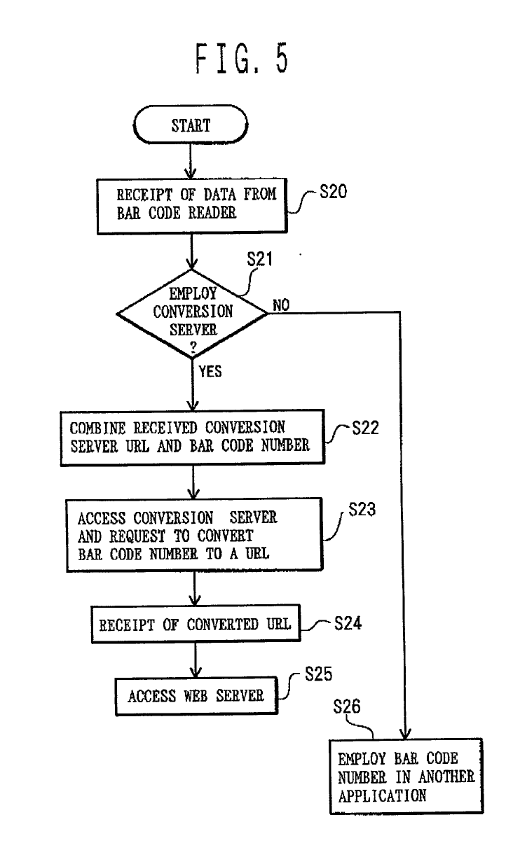

FIG. 5 is a flow chart for processing by a client.

S20: Data is received from the bar code reader.

S21: A judgment is made, as to whether or not a conversion server should be employed, by analyzing the data received.

S22: When a conversion server is employed, the received conversion server URL and bar code number are combined to generate a conversion request, which is to be sent to a conversion server, such as that noted below;

http://www.mediapj.com/bar.php?kind=01&sno=xxx&bno=yyyy

Here yyyyy is a code that corresponds to the bar code number.

S23: A request is made to access the conversion server and convert the bar code number to a URL.

S24: The converted URL is received.

S25: A Web server is accessed on the basis of the received URL.

S26: When a conversion server is not employed, the received bar code number is employed in another application; for example, when an employee number or password, or the like, is to be input.

By means of the device/method of the embodiment of the present invention, by a bar code being made to contain plural identifiers, a single bar code can be matched to a plurality of URLs, thus permitting access to any given server. In other words, a user can be easily directed to a specific one chosen from among a plurality of servers.

Such a capability is of benefit to a provider of a bar code and/or bar code reader. For example, when a marketing company supplies a user with a bar code reader and performs electronic business transactions via the company's server by means of a bar code provided on a leaflet, upon reading such a bar code using the company's bar code reader (even if the leaflet is for another company), the user can be directed to the company server. Accordingly, it is possible to prevent a user from accessing to a conversion server and/or web server of another store, using a dedicated bar code reader which has been supplied by the company.

In addition, modification of the relation between a bar code and a URL can be performed flexibly by rewriting of the E2PROM. For instance, in the above-mentioned example, if a plurality of companies collaborate together in the planning of an advertisement, when a bar code is printed on the advertisement, it is possible to set periods for directing the user to different company servers.

Alternatively, the server, to which a user is directed, may also be switched on the basis of the number of times a server has been accessed by the user. For example, a user is directed to the server of the URL conversion service provider the first time access is attempted and the user is prompted to register. However, the second time and thereafter, the user can be directed to another server, such as a provider server or mobile telephone telecommunications carrier server, for example. This can be implemented simply if the E2PROM table is rewritten the first time access takes place.

Modified Example 1 of the First Embodiment of the Invention

As described above, which conversion server is to be accessed is determined on the basis of the identifier contained in the bar code. Instead, or in addition, the conversion server to be accessed may also be determined on the basis of bar code information about the connecting party.

For example, when a bar code reader is connected to a client, both communicate with one another, and the bar code reader receives an identifier that indicates the kind of client being employed, which identifier is then stored. The conversion server URL is thus established on the basis of this identifier.

When the connecting party is a personal computer, a mobile telephone or a digital TV, conversion is performed as noted below, for example.

For a personal computer: http://www.mediapj.com/

For a mobile telephone: http://www.hogehoge.com/

For a digital TV: http://www.foo.com/

Subsequent processing is like that for the case described earlier.

According to this embodiment, the connecting party of the bar code is continually able to employ an optimum conversion server. By carrying around only a bar code reader, when required, connection to the nearest client permits straightforward use of a bar code-URL conversion service. In a system in which a client may be a personal computer, mobile telephone or digital TV, even when the same bar code is scanned, the sites (servers) that are to be accessed are respectively different, depending on the kind of client. For example, it is desirable that a personal computer should access an ordinary Web site (HTML site), a mobile telephone a dedicated CHTML site, and a digital TV a dedicated BML site. This is because the language used is limited to the language that is usable by each client, and because there is a requirement for access to be made to the sites noted above using a usable language in order to appropriately display the content.

According to this embodiment, a plurality of conversion servers are provided for use by a personal computer, a mobile telephone or digital TV, and by pre-storing, in a table, the most appropriate URLs for a personal computer, a mobile telephone and digital TV respectively, the user is not required to provide settings for each kind of client. Rather, accessing of the most appropriate site can be performed automatically. Modified Example 2 of the first embodiment of the present invention.

In the above-mentioned modified example 1, which server is to be accessed is determined on the basis of the bar code information about the connecting party. Instead, or in addition, the conversion server to be accessed may also be determined on the basis of the identifier that is pre-stored in the bar code reader. For example, when the identifier for the bar code provider is pre-stored in the bar code reader and the code is read, a URL is output for access to this provider server.

When the bar code provider identifier is stored in storage portion 13, the content of this identifier can be updated in addition to the table, as discussed above.

According to this embodiment for example, it is possible for the user to be directed to the company server whenever a bar code is read, and irrespective of the kind of bar code.

Second Embodiment of the Invention

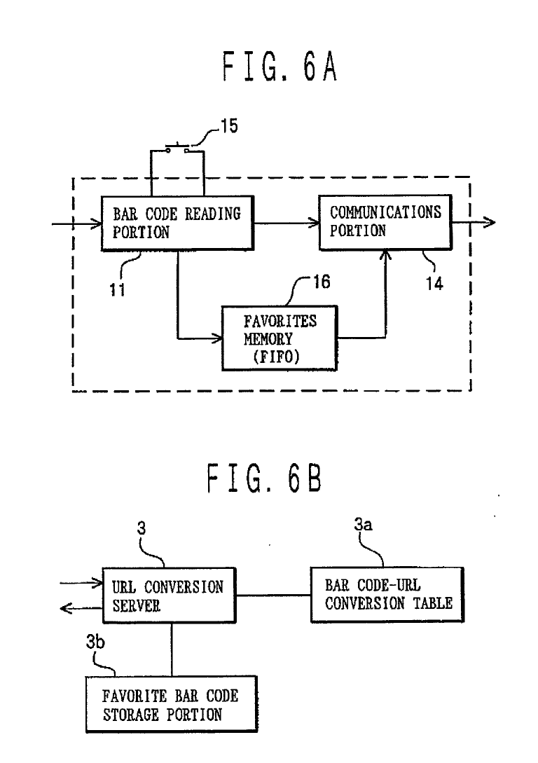

A device/method for registering a bar code for “favorites” (frequently referenced bar code numbers which can be read out by means of a simple operation) can be provided in a bar code reader and/or URL conversion server. FIG. 6(a) is a block diagram of a bar code reader for this purpose, and FIG. 6(b) is a block diagram of a URL conversion server 1 for this purpose.

The bar code reader of FIG. 6(a) comprises a switch 15 for registering scanned bar codes as favorites, and a memory 16 for storing these favorite bar codes. Memory 16 is, for example, a first-in first-out (FIFO) memory. When memory 16 cannot store new data on account of being full, initial data can be output in order to free up memory capacity and permit the storage of new data. If memory 16 is provided in bar code reader 1, storage of favorite bar codes is made simple, and, even when bar code reader 1 is connected to another client, these favorites can be used. On the other hand, since the storage capacity of memory 16, which is provided in bar code reader 1, is not very large, the number of favorites that can be registered is limited. As a result, a portion of data in bar code reader 1 in FIG. 6(a) is output, that is, sent to URL conversion server 3, and, through storage thereon, it is possible to compensate for the shortage of storage capacity of memory 16. Further, the memory used is not limited to a FIFO, but may instead be a FILO (first-in last-out) memory. Further, infrequently used bar codes may be output.

When receiving the favorite bar code numbers from the bar code reader in FIG. 6(a), the URL conversion server 1 of FIG. 6(b) stores these bar code numbers in favorite bar code storage portion 3b. For example, data such as that noted below is stored.

| User ID | Favorite ID | Favorite bar code numbers |
|---|---|---|
| A | 1 | 12345 |
| A | 2 | 23456 |
| B | 1 | 34567 |

When a request for a favorite is made by the user, server 3 acquires a bar code number on the basis of the favorite ID. subsequent processing is like that for the case described earlier.

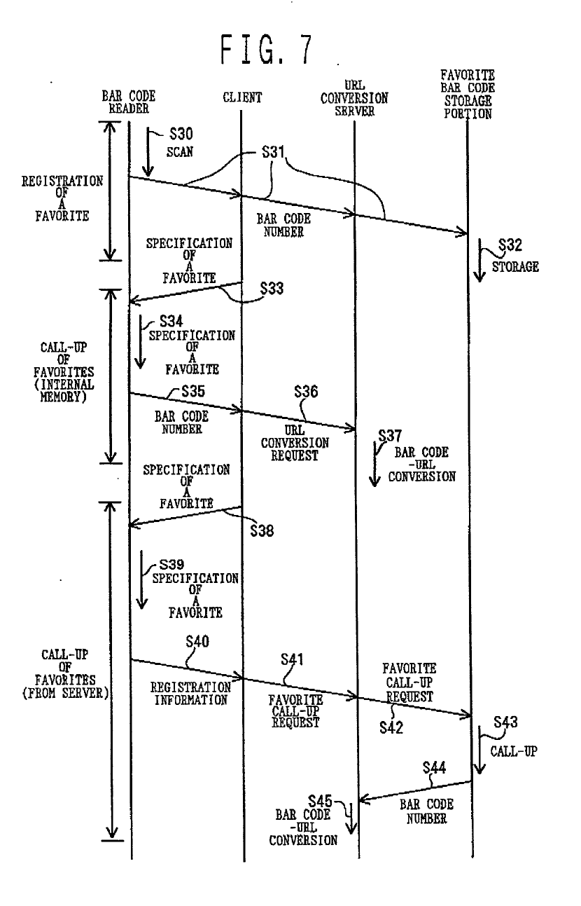

FIG. 7 is a flow chart for processing relating to the embodiment of the present invention. An explanation in this regard is added hereinbelow.

<Registration of a Favorite>

S30: A bar code is scanned using a bar code reader. The newly obtained bar code number is stored in memory 16.

S31: When memory 16 is full, excess bar code numbers that cannot be stored as per S30, are sent to URL conversion server.

S32: Bar code numbers that are sent are stored in favorite barcode storage portion 3b.

Further, favorite bar code numbers may also be sent directly to URL conversion server without using memory 16.

<Call-up of Favorites (Internal Memory)>

S33: Any of the favorite bar codes is specified using a client.

S34: Alternatively, a favorite may also be specified using a bar code reader.

S35: When a favorite is stored in memory 16, a corresponding bar code number is read out from memory 16, and sent to the client.

S36: This bar code number is sent to the URL conversion server.

S37: Bar code-URL conversion is performed using the URL conversion server.

Subsequent processing is like that in the case described for the first embodiment of the invention.

<Call-up of Favorites (from the Server)>

S38: Any of the favorite bar codes is specified using a client.

S39: Alternatively, a favorite is specified using a bar code reader.

S40: When no such favorite is stored in memory 16, favorite registration information is sent to the client.

S41: A favorite call-up request is sent from the client to the URL conversion server.

S42 to S44: The URL conversion server reads out the specified bar code number from storage portion 3b.

S45: The read-out bar code is converted to a URL,

Subsequent processing is like that in the case described for the first embodiment of the invention.

By means of the device/method relating to the second embodiment of the present invention, it is possible to establish favorites in the bar code reader and to also deal with a large number of favorites. Furthermore, costs are very low.

The present invention is not limited to the embodiments above. Rather, it goes without saying that, within the scope of the inventions appearing in the claims, a variety of modified embodiments are possible that are equally covered by the scope of the present invention.

Furthermore, the means described in the present specification are not necessarily to be understood as being physical means. Cases where the function(s) of each means is (are) implemented by software are also covered. In addition, the function(s) of a single means may also be realized by two or more physical means, or the function(s) of two or more means may also be realized by a single physical means.

What is claimed is:

1. A bar code reader, comprising:
a bar code reading portion for reading a bar code;
a storage portion for pre-storing the relation between an identifier and a server URL;
an analyzing portion for extracting an identifier from a read bar code and for obtaining a corresponding URL by searching said storage portion on the basis of said identifier; and
a communications portion for transmitting at least said URL.

2. The bar code reader according to claim 1, wherein said analyzing portion outputs information signifying non-employment of a server to said communications portion when a corresponding URL is not present.

3. The bar code reader according to claim 1, wherein said storage portion comprises a memory that is capable of being rewritten, and said communications portion receives a data input that relates to said relation, and writes this data to said memory.

4. The bar code reader according to claim 3, wherein said communications portion sends out a request for said relation to be updated at at least one time selected from among:
a time when initial settings are made, every time a predetermined interval has elapsed, every time a predetermined number of read processings have been performed, and after a specific server has been accessed.

5. A bar code reader, comprising;
a bar code reading portion for reading a bar code;
a storage portion for pre-storing the relation between a connecting party and a server URL, and for storing information on the connecting party;
an analyzing portion for obtaining a corresponding URL by searching said storage portion on the basis of said information on the connecting party; and
a communications portion for transmitting at least said URL and, during connection with said connecting party, for obtaining said connecting party information and storing same in said storage portion.

6. The bar code reader according to claim 5, wherein said analyzing portion outputs information signifying non-employment of a server to said communications portion when a corresponding URL is not present.

7. The bar code reader according to claim 5, wherein said storage portion comprises a memory that is capable of being rewritten, and said communications portion receives a data input that relates to said relation, and writes this data to said memory.

8. The bar code reader according to claim 7, wherein said communications portion sends out a request for said relation to be updated at at least one time selected from among:
a time when initial settings are made, every time a predetermined interval has elapsed, every time a predetermined number of read processings have been performed, and after a specific server has been accessed.

9. The bar code reader according to claim 5, wherein said relation between said connecting party and server URL includes the relation between a mobile telephone and server URL and the relation between a mobile telephone and a URL for a telecommunications carrier server; and, when said connecting party is a mobile telephone, when a bar code is initially read, said server URL is obtained, and thereafter a URL for said telecommunications carrier server is obtained.

10. A bar code reader, comprising:
a bar code reading portion for reading a bar code;
a storage portion for pre-storing the relation between an identifier and a server URL and for storing said identifier;
an analyzing portion for obtaining a corresponding URL by searching said storage portion on the basis of said identifier; and
a communications portion for transmitting at least said URL.

11. The bar code reader according to claim 10, wherein said analyzing portion outputs information signifying non-employment of a server to said communications portion when a corresponding URL is not present.

12. The bar code reader according to claim 10, wherein said storage portion comprises a memory that is capable of being rewritten, and said communications portion receives said identifier as an input and writes this identifier to said memory, and sends out a request for said identifier to be updated at at least one time selected from among: a time when initial settings are made, every time a predetermined interval has elapsed, every time a predetermined number of read processings have been performed, and after a specific server has been accessed.

13. A bar code reader, comprising:
a bar code reading portion for reading a bar code;
a switch for specifying an identifier;
a storage portion for pre-storing the relation between said identifier and server URL;
an analyzing portion for obtaining a corresponding URL by searching said storage portion on the basis of the identifier specified by said switch; and
a communications portion for transmitting at least said URL.

14. The bar code reader according to claim 13, wherein said analyzing portion outputs information signifying non-employment of a server to said communications portion when a corresponding URL is not present.

15. The bar code reader according to claim 13, wherein said storage portion comprises a memory that is capable of being rewritten, and said communications portion receives a data input that relates to said relation, and writes this data to said memory.

16. The bar code reader according to claim 15, wherein said communications portion sends out a request for said relation to be updated at at least one time selected from among:
a time when initial settings are made, every time a predetermined interval has elapsed, every time a predetermined number of read processings have been performed, and after a specific server has been accessed.

17. A bar code reader, comprising:
a bar code reading portion for reading a bar code;
a favorites memory for storing specified bar code data as a new favorite, and a communications portion for transmitting said bar code data.

18. The bar code reader according to claim 17, wherein, when new data cannot be stored, said favorites memory ensures that there is a storage location for new data by removing at least a portion of data from the favorites memory and sending same to said communications portion; when an instruction to read out favorites data is received, the favorites memory reads out corresponding data and outputs same; and, when no favorites data is specified, requests data from said communications portion; and wherein
said communications portion sends an output, in order that data received from said favorites memory is stored on a server, and receives favorites data from said server by outputting a request received from said memory to said server.

19. A method of accessing a plurality of servers on the basis of a bar code, comprising the steps of:
storing a table that indicates the relation between identifiers and server URLs;
reading a bar code;
extracting an identifier from the read bar code;
obtaining a corresponding URL by searching said table on the basis of said identifier; and
accessing a server on the basis of said URL.

20. The method of accessing a plurality of servers on the basis of a bar code according to claim 19, comprising the steps of:
transmitting a request to update said table;
searching for an updated table;
transmitting a new table, which has been searched for; and
updating said table through reception of the new table.

21. The method of accessing a plurality of servers on the basis of a bar code according to claim 19, wherein said step of accessing a server on the basis of said URL comprises the steps of:
receiving data of a read bar code;
generating a URL conversion request by combining said URL and said bar code data;
sending said URL conversion request;
receiving a converted URL; and
accessing a server on the basis of said converted URL.
